(19) United States
(12) Patent Application Publication
(10) Pub. No.: US 2015/0200514 A1
(43) Pub. Date: Jul. 16, 2015

(54) METHOD FOR CALIBRATING A PLURALITY OF PINCETTES OF A WAFER CONVEYER

(71) Applicant: UNITED MICROELECTRONICS CORP., Hsin-Chu City (TW)

(72) Inventor: Yi-Chang Chen, Taichung City (TW)

(73) Assignee: UNITED MICROELECTRONICS CORP., Hsin-Chu City (TW)

(21) Appl. No.: 14/153,089

(22) Filed: Jan. 13, 2014

(51) Int. Cl. H01R 43/22

(52) U.S. Cl. CPC H01R 43/22

(57) ABSTRACT

Calibrating a plurality of pincettes of a wafer conveyer includes installing a first pincette on two first components moveably installed on two first guiding tracks formed along a horizontal direction, installing a second pincette on two second components moveably installed on two second guiding tracks formed along the horizontal direction, disposing a first disc formed with three positioning components on a first holding portion of the first pincette, disposing a second disc formed with three positioning rings on a second holding portion of the second pincette, positioning three poles on the three positioning components through the three positioning rings, and fine tuning relative positions between the first pincette and the two first components and relative positions between the second pincette and the two second components to position the first pincette and the second pincette to horizontal levels according to indications of inclinometers disposed on three beams connecting the three poles.

### BACKGROUND OF THE INVENTION

1. Field of the Invention

The present invention relates to a method for aligning a plurality of pincettes, and more specifically, to a method for aligning a plurality of pincettes by using a coaxial alignment tool.

2. Description of the Prior Art

In semiconductor fabrication, circuits are formed on wafers of a semiconductor material such as silicon. A single crystal of the semiconductor material is sliced into thin wafers and the wafers are transported between various stations, such as processing stations, storage stations, and queuing stations, in the fabrication plant. The fabrication plant must be kept clean to prevent contamination of the semiconductor wafers. The wafers are handled with care in sealed clean-room environments.

Robots are often used to transport the wafers between processing, storage, queuing and other stations. A typical robotic arm includes two or three pincettes that can be moved vertically or horizontally. The pincettes are used to pick up and drop off wafers. In addition, in order to pick up and drop off wafers with a high precision and to prevent the wafers from being damaged, the pincettes need to be aligned to each other and be adjusted to horizontal levels. Once a while the robot is due for maintenance or repair, at this time, the pincettes need to be detached from the robot and then be installed back to the robot. Whenever this occurs, an alignment of the pincettes has to be performed again by using a prior art coaxial alignment tool.

Please refer to FIG. 1 and FIG. 2, FIG. 1 is a diagram illustrating a prior art coaxial alignment tool 10 used to align two pincettes 21, 22 of a robot in a semiconductor manufacturing system. FIG. 2 is a side view of the prior art coaxial alignment tool 10 in FIG. 1. The coaxial alignment tool 10 includes a first disc 11 with a positioning component 111, a second disc 12 with a positioning ring 121, and a pole 13. The first disc 11 and the second disc 12 have the same shape, and the positioning ring 121 is integrated to the second disc 12 corresponding to the positioning component 111 integrated to the first disc 11. The pole 13 is disposed on the recess of the positioning component 111 through the positioning ring 121, so as to align the first disc 11 to the second disc 12. As shown in FIG. 1, by aligning the first disc 11 and the second disc 12 through the coaxial alignment tool 10, the two pincettes 21, 22 can be aligned.

However, as shown in FIG. 2, there are gaps between the pole 13 and an inner surface 122 of the positioning ring 121 and between the pole 13 and an inner surface 124 of the positioning component 111. The gaps may cause a misalignment between the first disc 11 and the second disc 12, thereby failing to align the two pincettes 21, 22 accurately. Besides, the coaxial alignment tool 10 provides no means to check if the two pincettes 21, 22 are positioned at horizontal levels. This may damage wafers when wafers are being conveyed from one position to another by the robot. Therefore, it is an important issue to provide a method for calibrating the pincettes by using an improved coaxial alignment tool, to solve the above problems.

### SUMMARY OF THE INVENTION

A method for calibrating a plurality of pincettes of a wafer conveyer includes installing a first pincette on two first components moveably installed on two first guiding tracks formed along a horizontal direction, installing a second pincette on two second components moveably installed on two second guiding tracks formed along the horizontal direction, disposing a first disc formed with three positioning components on a first holding portion of the first pincette, disposing a second disc formed with three positioning rings on a second holding portion of the second pincette, positioning three poles on the three positioning components through the three positioning rings, and fine tuning relative positions between the first pincette and the two first components and relative positions between the second pincette and the two second components to position the first pincette and the second pincette to horizontal levels according to indications of a plurality of inclinometers disposed on at least two of three beams connecting the three poles.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art coaxial alignment tool used to align two pincettes of a robot in a semiconductor manufacturing system.

FIG. 2 is a side view of the prior art coaxial alignment tool in FIG. 1.

FIG. 3 is a perspective view of a wafer conveyer according to an embodiment of the present invention.

FIG. 4 is a block diagram of the wafer conveyer.

FIG. 5 is a diagram of a chassis according to the embodiment of the present invention.

FIG. 6 is a sectional view of the chassis according to the embodiment of the present invention.

FIG. 7 and FIG. 8 are diagrams illustrating that a coaxial alignment tool is disposed on a first pincette and a second pincette according to one embodiment of the present invention.

FIG. 9 and FIG. 10 are diagrams illustrating that the coaxial alignment tool is disposed on the first pincette, the second pincette and a third pincette according to another embodiment of the present invention.

FIG. 11 is a flowchart of a method for calibrating pincettes by the coaxial alignment tool according to the embodiment of the present invention.

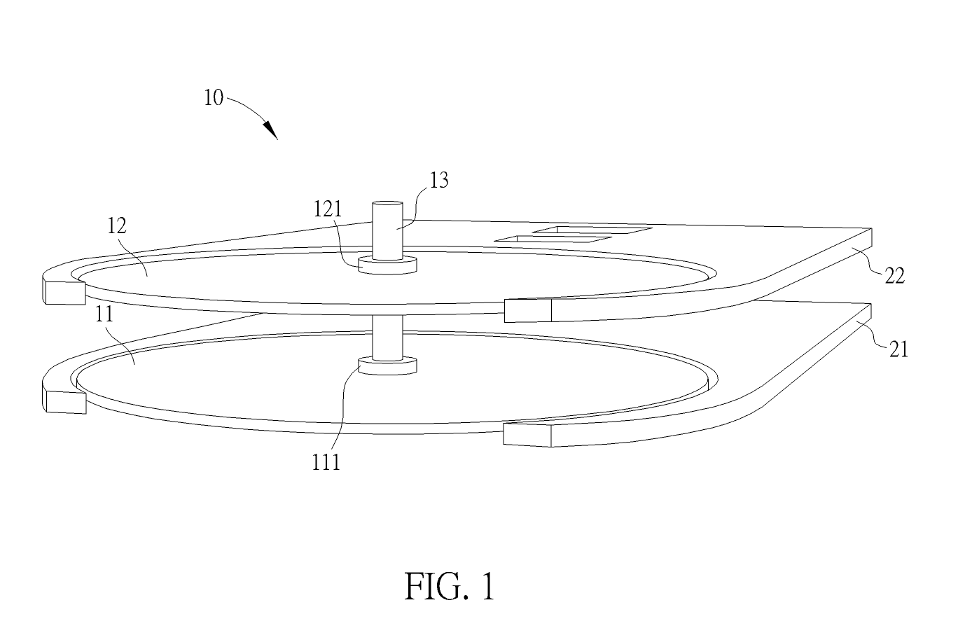

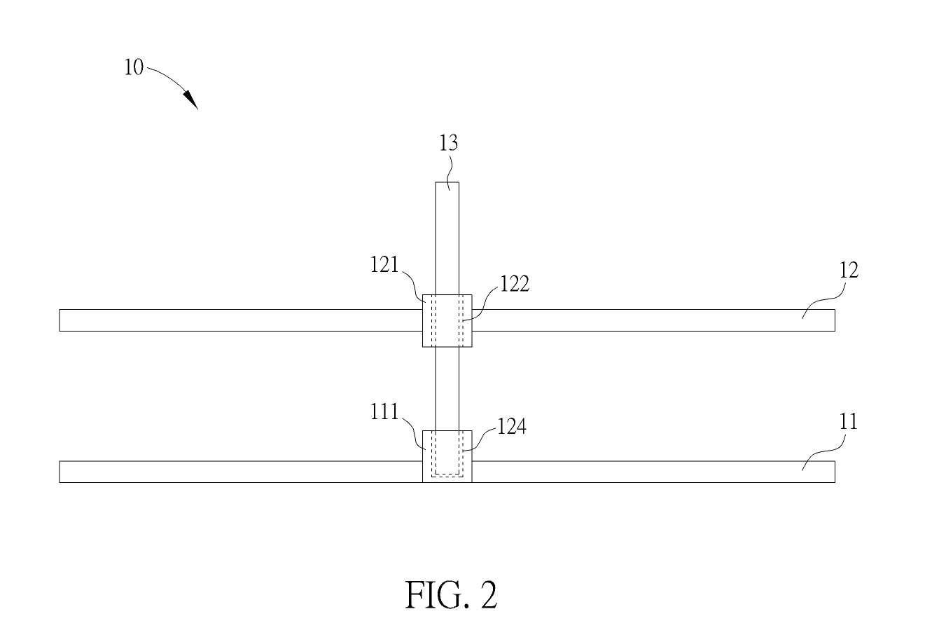

### DETAILED DESCRIPTION

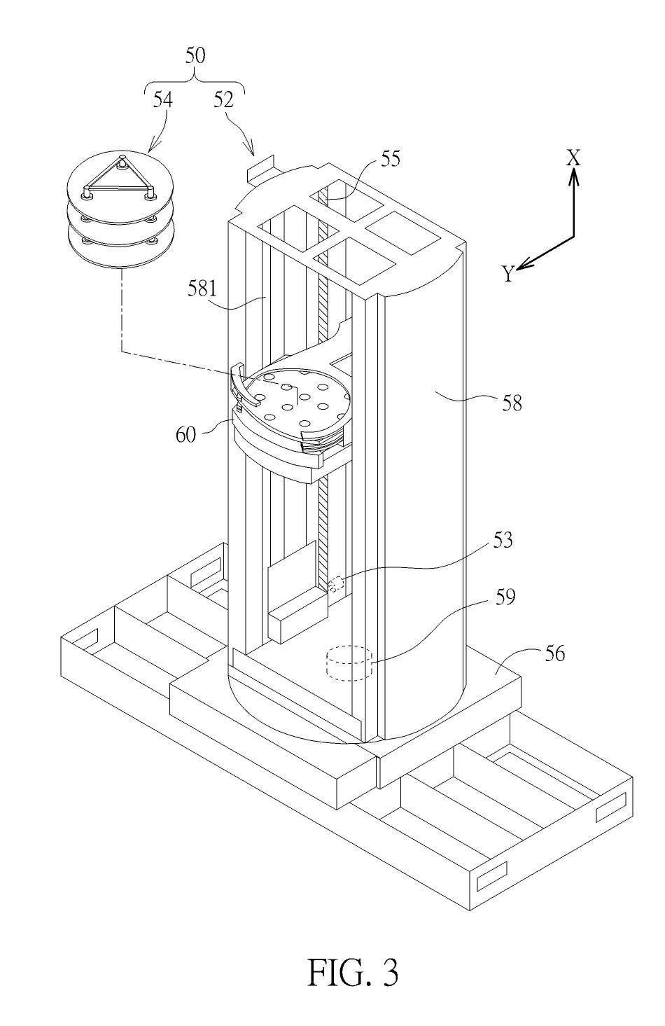

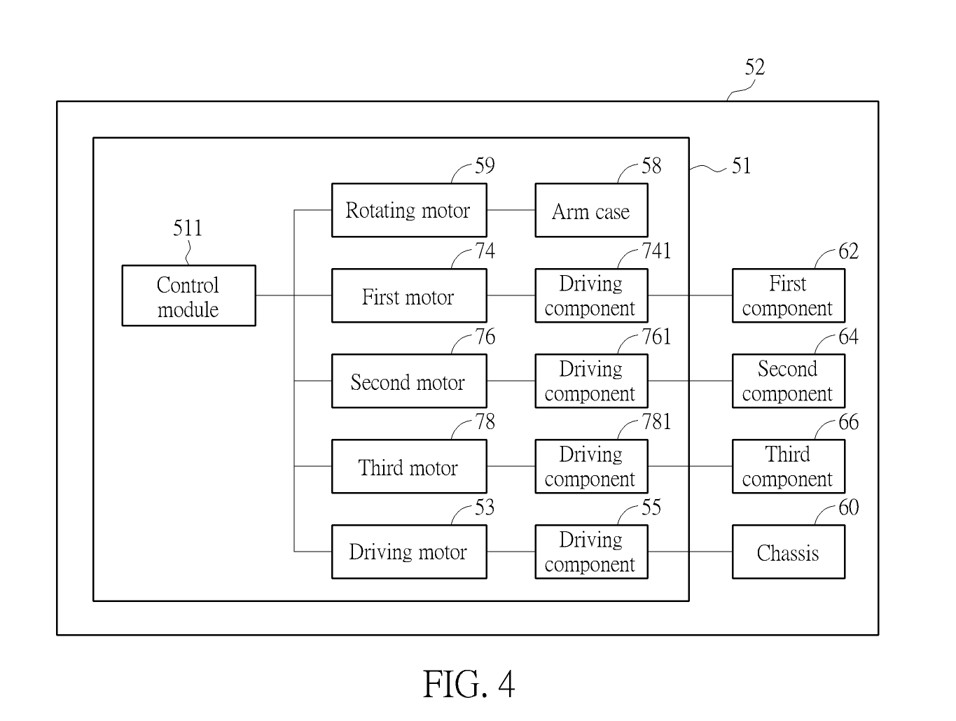

Please refer to FIG. 3 and FIG. 4. FIG. 3 is a perspective view of a wafer conveyer 50 according to an embodiment of the present invention. FIG. 4 is a block diagram of the wafer conveyer 50. The wafer conveyer 50 is for conveying wafers and includes a main arm 52 and a coaxial alignment tool 54 disposed on the main arm 52. The main arm 52 includes a driving device 51, a base 56, an arm case 58 and a chassis 60. The arm case 58 is rotatably disposed on the base 56. The driving device 51 includes a control module 511 and a rotating motor 59 electrically connected to the control module 511. The rotating motor 59 is installed inside the base 56 and connected to the arm case 58. The control module 511 is for controlling the rotating motor 59 to rotate the arm case 58 along a clockwise and/or a counterclockwise direction. The arm case 58 has a vertical guiding track 581 formed along a vertical direction X, and the chassis 60 is movably installed on the vertical guiding track 581. In addition, a driving motor 53 electrically connected to the control module 511 and a driving component 55 connected to the driving motor 53 and the chassis 60 are installed inside the arm case 58. The control module 511 is for controlling the driving motor 53 to drive the driving component 55, so as to move the chassis 60 upward and downward along the vertical guiding track 581 in the vertical direction X. The driving component 55 can be a gear or a chain, and is not limited to this embodiment.

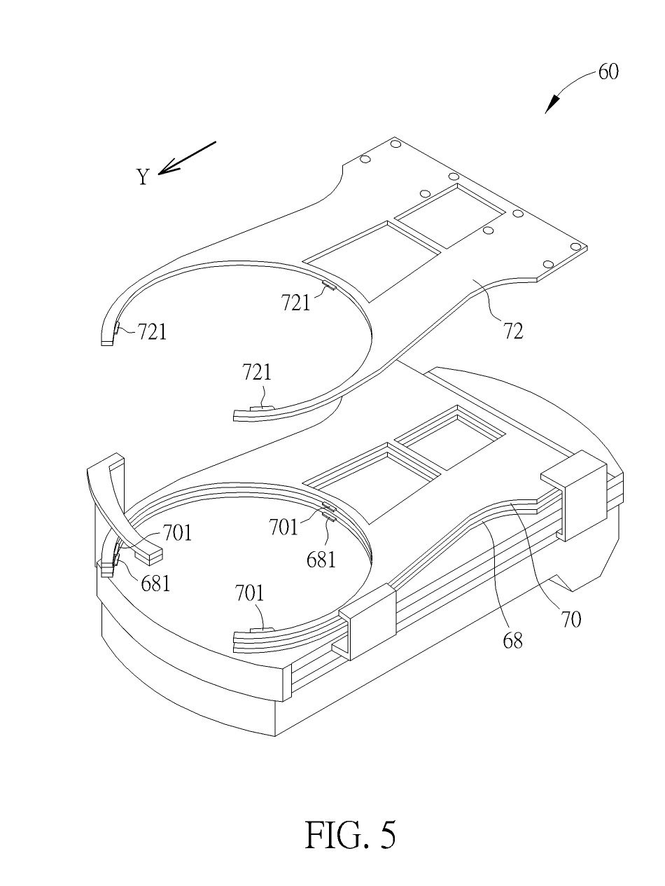

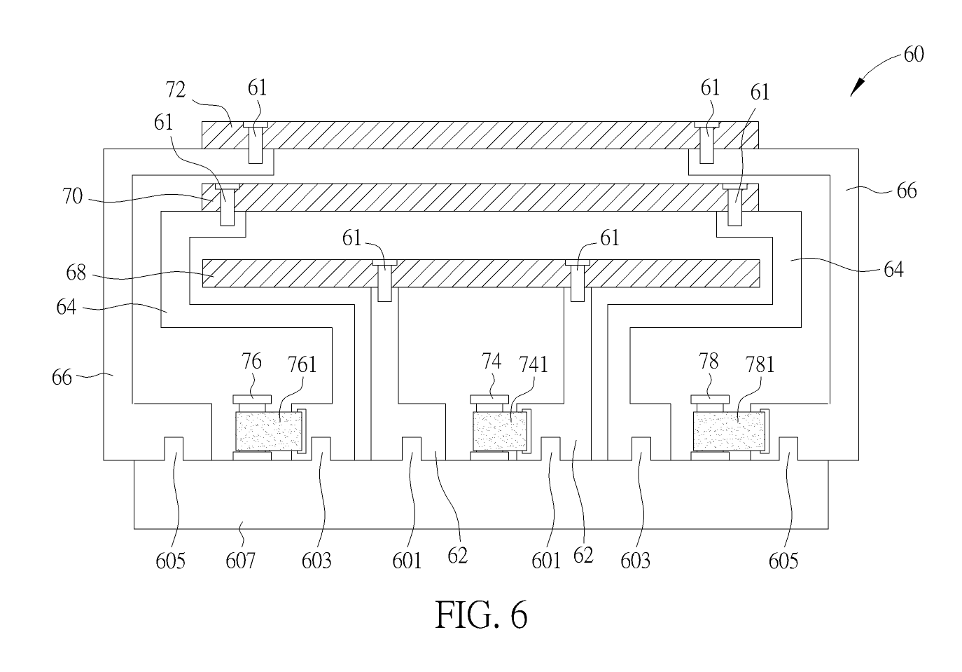

Please refer to FIG. 5 and FIG. 6. FIG. 5 is a diagram of the chassis 60 according to the embodiment of the present invention. FIG. 6 is a sectional view of the chassis 60 according to the embodiment of the present invention. As shown in FIG. 6, there are two first guiding tracks 601, two second guiding tracks 603 and two third guiding tracks 605 formed on the bottom 607 of the chassis 60. In addition, the chassis 60 includes two first components 62, two second components 64 and two third components 66. The two first components 62 are moveably installed on the two first guiding tracks 601 formed along a horizontal direction Y shown in FIG. 5. The two second components 64 are moveably installed on the two second guiding tracks 603 formed along the horizontal direction Y. The two third components 66 are moveably installed on the two third guiding tracks 605 formed along the horizontal direction Y. As shown in FIG. 5 and FIG. 6, a first pincette 68 is detachably installed on the two first components 62, and includes three first holding portions 681. A second pincette 70 is detachably installed on the two second components 64, and includes three second holding portions 701. A third pincette 72 is detachably installed on the two third components 66, and includes three third holding portions 721. In the present invention, the main arm 52 further includes a plurality of screws 61 for adjustably fixing the first pincette 68, the second pincette 70 and the third pincette 72 on the two first components 62, the two second components 64 and the two third components 66 respectively.

In addition, as shown in FIG. 4 and FIG. 6, the main arm 52 further includes a first motor 74, a second motor 76 and a third motor 78. The first motor 74, the second motor 76 and the third motor 78 are electrically connected to the control module 511. The first motor 74 is connected to one of the two first components 62 by a driving component 741, the second motor 76 is connected to one of the two second components 64 by a driving component 761, and the third motor 78 is connected to one of the two third components 66 by a driving component 781. Therefore, the control module 511 can control the first motor 74 to drive the two first components 62 with the first pincette 68 to move along the two first guiding tracks 601 in the horizontal direction Y, the control module 511 can control the second motor 76 to drive the two second components 64 with the second pincette 70 to move along the two second guiding tracks 603 in the horizontal direction Y, and the control module 511 can control the third motor 78 to drive the two third components 66 with the third pincette 72 to move along the two third guiding tracks 605 in the horizontal direction Y. Therefore, the first pincette 68, the second pincette 70 or the third pincette 72 can move along the horizontal direction Y to convey the wafers. In the present invention, the driving components 741, 761 and 781 can be chains or belts, and are not limited to this embodiment. Driving components capable of driving the two first components 62, the two second components 64 and the two third components 66 to move are within the scope of the present invention.

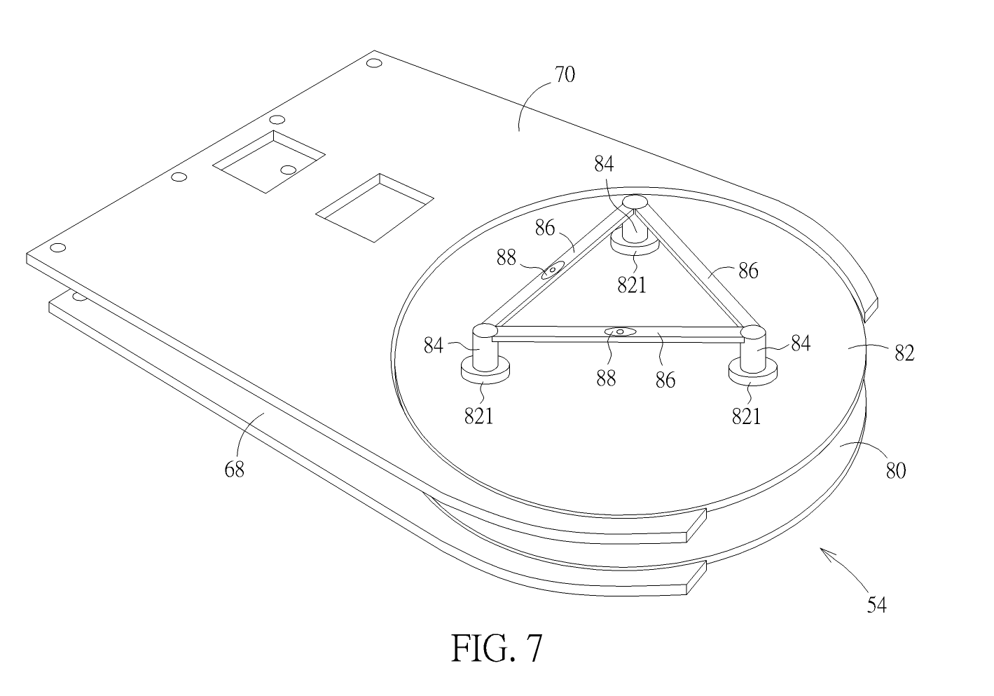

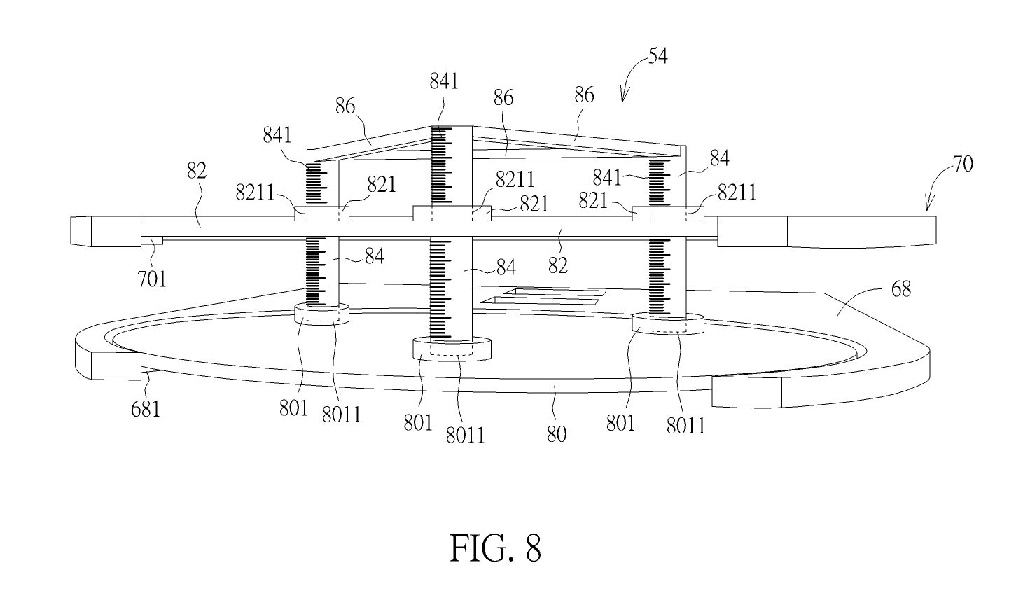

Please refer to FIG. 7 and FIG. 8. FIG. 7 and FIG. 8 are diagrams illustrating that the coaxial alignment tool 54 is disposed on the first pincette 68 and the second pincette 70 according to one embodiment of the present invention. In this embodiment, the coaxial alignment tool 54 includes a first disc 80, a second disc 82, three poles 84, three beams 86 and two inclinometers 88. The first disc 80 is formed with three positioning components 801, and the second disc 82 is formed with three first positioning rings 821 corresponding to the three positioning components 801. As shown in FIG. 8, each of the three positioning components 801 has a recess 8011 for positioning the corresponding pole 84, and each of the three first positioning rings 821 has a through hole 8211 for positioning the corresponding pole 84. Therefore, the three poles 84 are positioned on the three positioning components 801 through the three first positioning rings 821. Each of the three beams 86 is connected between two of the three poles 84. The two inclinometers 88 are disposed on two of the three beams 86 to check if the first disc 80 and the second disc 82 are positioned at horizontal levels. The coaxial alignment tool 54 of the present invention including the three poles 84 can eliminate the error due to the gaps between the pole 13 and the positioning ring 121 and between the pole 13 and the positioning component 111 of the prior art coaxial alignment tool 10.

When the wafer conveyer 50 is to be repaired, the first pincette 68 and the second pincette 70 are detached from the two first components 62 and the two second components 64 respectively. After the repair is done, the first pincette 68 and the second pincette 70 are installed back to the two first components 62 and the two second components 64, and the coaxial alignment tool 54 can be disposed on the first holding portions 681 and the second holding portions 701. Then, the first pincette 68 and the second pincette 70 can be aligned accurately and adjusted to the horizontal levels by using the coaxial alignment tool 54, so as to prevent the wafers from being damaged when conveying the wafers. In addition, as shown in FIG. 8, each of the poles 84 has a scale 841 for indicating the space between the first disc 80 and the second disc 82. When all three scales 841 show a consistent space between the first disc 80 and the second disc 82 and the inclinometers 88 indicate the beams 86 are at horizontal levels, the alignment is accomplished.

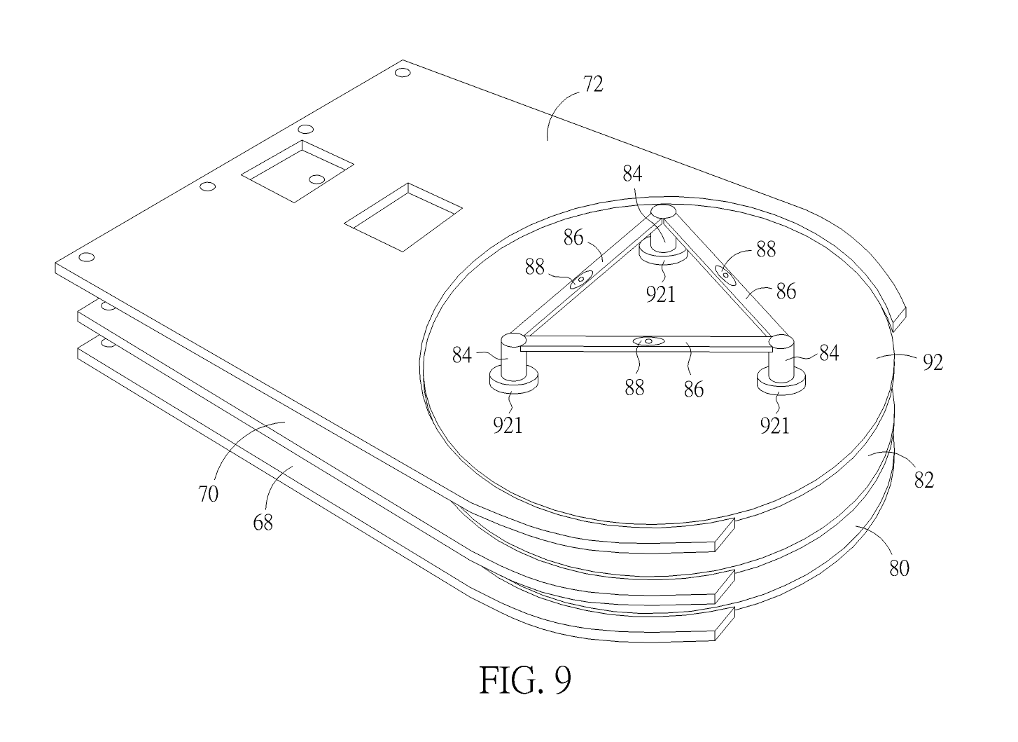

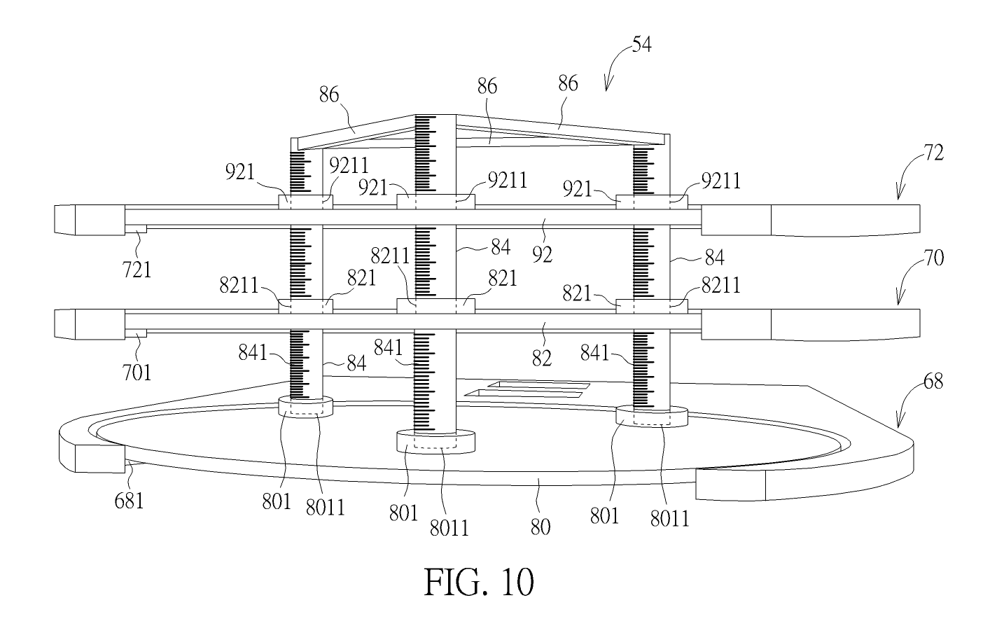

Furthermore, the number of discs and the number of inclinometers are not limited to this embodiment. For example, please refer to FIG. 9 and FIG. 10. FIG. 9 and FIG. 10 are diagrams illustrating that the coaxial alignment tool 54 is disposed on the first pincette 68, the second pincette 70 and the third pincette 72 according to another embodiment of the present invention. In this embodiment, the coaxial alignment tool 54 further includes a third disc 92 with three second positioning rings 921, and the three second positioning rings 921 are formed corresponding to the three positioning components 801 and the three second positioning rings 821. Each of the three second positioning rings 921 has a through hole 9211, and the three poles 84 are positioned on the three positioning components 801 through the through holes 8211 of the three first positioning rings 821 and the through holes 9211 of the second positioning rings 921.

After the first pincette 68, the second pincette 70 and the third pincette 72 are installed, the coaxial alignment tool 54 can be disposed on the first holding portions 681, second holding portions 701 and third holding portions 721. Then, the first pincette 68, the second pincette 70 and the third pincette 72 can be aligned to one another and the first pincette 68, the second pincette 70 and the third pincette 72 can be positioned to horizontal levels with the coaxial alignment tool 54. In this embodiment, as shown in FIG. 9, the coaxial alignment tool 54 includes three inclinometers 88 on the three beams 86, however two inclinometers 88 are sufficient to check if the three pincettes 68, 70, 72 are positioned to the horizontal levels.

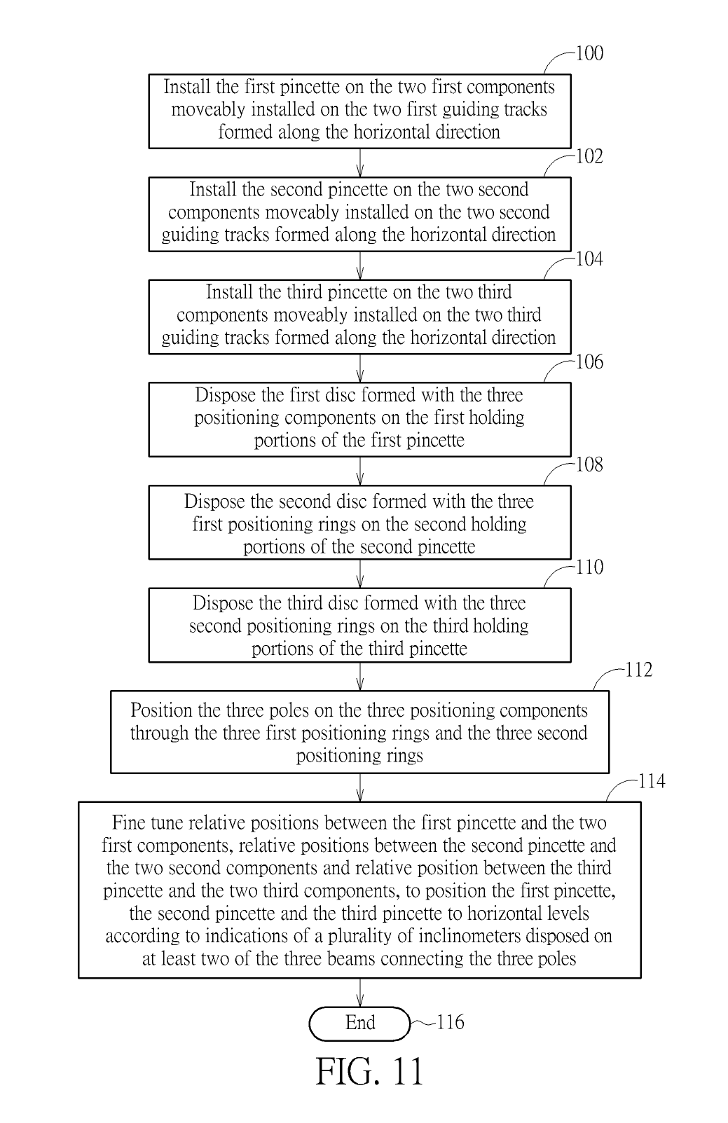

A method for calibrating the pincettes by the coaxial alignment tool 54 is described as follows. The method can be used for the coaxial alignment tool 54 with two discs or three discs, and the following steps are described with the coaxial alignment tool 54 with three discs. Please refer to FIG. 5 to FIG. 7, FIG. 8 and FIG. 11. FIG. 11 is a flowchart of the method for calibrating the pincettes by the coaxial alignment tool 54 according to the embodiment of the present invention. The method includes the following steps:

Step 100: Install the first pincette 68 on the two first components 62 moveably installed on the two first guiding tracks 601 formed along the horizontal direction Y;

Step 102: Install the second pincette 70 on the two second components 64 moveably installed on the two second guiding tracks 603 formed along the horizontal direction Y;

Step 104: Install the third pincette 72 on the two third components 66 moveably installed on the two third guiding tracks 605 formed along the horizontal direction Y;

Step 106: Dispose the first disc 80 formed with the three positioning components 801 on the first holding portions 681 of the first pincette 68;

Step 108: Dispose the second disc 82 formed with the three first positioning rings 821 on the second holding portions 701 of the second pincette 70;

Step 110: Dispose the third disc 92 formed with the three second positioning rings 921 on the third holding portions 721 of the third pincette 72;

Step 112: position the three poles 84 on the three positioning components 801 through the three first positioning rings 821 and the three second positioning rings 921;

Step 114: Fine tune relative positions between the first pincette 68 and the two first components 62, relative positions between the second pincette 70 and the two second components 64 and relative position between the third pincette 72 and the two third components 66, to position the first pincette 68, the second pincette 70 and the third pincette 72 to horizontal levels according to indications of a plurality of inclinometers 88 disposed on at least two of the three beams 86 connecting the three poles 84;

Step 116: End.

Detail description of previous steps is described herein. After the repair of the main arm 52 is done, the pincettes can be installed back to the chassis 60. In step 100, the engineer installs the first pincette 68 on the two first components 62 by the screws 61. In step 102, the engineer installs the second pincette 70 on the two second components 64 by the screws 61. In step 104, the engineer installs the third pincette 72 on the two third components 66 by the screws 61. After that, in step 106, the engineer disposes the first disc 80 on the first holding portions 681 of the first pincette 68. Then, in step 108, the engineer disposes the second disc 82 on the second holding portions 701 of the second pincette 70. In step 110, the engineer disposes the third disc 92 on the third holding portions 721 of the third pincette 72. Then, the engineer positions the three poles 84 on the three positioning components 801 through the three first positioning rings 821 and the three second positioning rings 921. Therefore, the first disc 80, the second disc 82 and the third disc 92 are aligned to each other accurately. Then, in step 114, the engineer can fine tune relative positions between the first pincette 68 and the two first components 62, relative positions between the second pincette 70 and the two second components 64 and relative position between the third pincette 72 and the two third components 66 by the screws 61, to position the first pincette 68, the second pincette 70 and the third pincette 72 to horizontal levels according to the indications of the two or three inclinometers 88 disposed on the three beams 86 connecting the three poles 84. That is, the engineer can align the first pincette 68, the second pincette 70 and the third pincette 72 to each other accurately according to the coaxial alignment tool 54 and can adjust the first pincette 68, the second pincette 70 and the third pincette 72 to the horizontal levels according to the indications of the two or three inclinometers 88 at the same time. As a result, the first pincette 68, the second pincette 70 and the third pincette 72 are aligned to each other and are adjusted to the horizontal levels. Finally, in step 116, the calibration is done, so that the wafers can be conveyed by the first pincette 68, the second pincette 70 or the third pincette 72 accurately and safely.

The present invention provides a method for calibrating the pincettes accurately by using the coaxial alignment tool. The coaxial alignment tool includes three poles to eliminate the error due to the gaps between the pole and the positioning ring and between the pole and the positioning component of the conventional coaxial alignment tool in the prior art. In addition, the coaxial alignment tool of the present invention includes at least two inclinometers to position the pincettes at the horizontal levels. As a result, the engineer can align at least two pincettes accurately and can adjust the at least two pincettes to the horizontal levels at the same time. Therefore, it solves the conventional problems that the misalignment is resulted from the gaps and the conventional coaxial alignment tool provides no means to adjusting the pincettes to the horizontal levels at the same time, resulting in damaging the wafers being conveyed by the pincettes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for calibrating a plurality of pincettes of a wafer conveyer, comprising:
installing a first pincette on two first components moveably installed on two first guiding tracks formed along a horizontal direction;
installing a second pincette on two second components moveably installed on two second guiding tracks formed along the horizontal direction;
disposing a first disc formed with three positioning components on a first holding portion of the first pincette;
disposing a second disc formed with three positioning rings on a second holding portion of the second pincette;
positioning three poles on the three positioning components through the three positioning rings; and
fine tuning relative positions between the first pincette and the two first components and relative positions between the second pincette and the two second components to position the first pincette and the second pincette to horizontal levels according to indications of a plurality of inclinometers disposed on at least two of three beams connecting the three poles.

2. A method for calibrating a plurality of pincettes of a wafer conveyer, comprising:
installing a first pincette on two first components moveably installed on two first guiding tracks formed along a horizontal direction;
installing a second pincette on two second components moveably installed on two second guiding tracks formed along the horizontal direction;
installing a third pincette on two third components moveably installed on two third guiding tracks formed along the horizontal direction;
disposing a first disc formed with three positioning components on a first holding portion of the first pincette;
disposing a second disc formed with three first positioning rings on a second holding portion of the second pincette;
disposing a third disc formed with three second positioning rings on a third holding portion of the third pincette;
positioning three poles on the three positioning components through the three first positioning rings and the three second positioning rings; and
fine tuning relative positions between the first pincette and the two first components, relative positions between the second pincette and the two second components and relative position between the third pincette and the two third components to position the first pincette, the second pincette and the third pincette to horizontal levels according to indications of a plurality of inclinometers disposed on at least two of the three beams connecting the three poles.
